(19) United States
(12) Patent Application Publication
(10) Pub. No.: US 2026/0127886 A1
(43) Pub. Date: May 7, 2026

(54) PROCESSING OF REFUSE CONTAMINATION MEDIA CAPTURED BY CAMERAS

(71) Applicant: WasteVision LLC, Scottsdale, AZ (US)

(72) Inventors: Phil Lamb, Eagle, CO (US); Barry Saunders, Scottsdale, AZ (US); Anthony Peter Genovese, Southborough, MA (US)

(21) Appl. No.: 19/394,600

(22) Filed: Nov. 19, 2025

Related U.S. Application Data
(63) Continuation-in-part of application No. 17/898,025, filed on Aug. 29, 2022, now Pat. No. 12,505,530.

(51) Int. Cl. G06V 20/52; G06T 7/00; G06V 10/764; G06V 20/40

(52) U.S. Cl. CPC G06V 20/52; G06T 7/0002; G06V 10/764; G06T 2207/10016; G06T 2207/20081; G06T 2207/20084; G06T 2207/30252; G06V 20/40

(57) ABSTRACT

Methods and systems for identifying individual materials from waste streams. A request can be received from a requester to assess waste within a waste container. Media in the form at least one of still images or video streams can be accessed from at least one camera located in association with a waste container. The media can be transmitted to an artificial intelligence (AI) platform for processing to determine the class of individual materials contained in the media and provide identification with a confidence level. A data file containing processing results can be created. A response can be generated and transmitted to the requester that initiated the request. The response can include data that further includes all materials found by the AI platform as contained in the media with a confidence level for each and at least one of an identification of the requester, container identification, and container location.

### CROSS-REFERENCE TO RELATED PATENT APPLICATION

This patent application is a continuation-in-part of U.S. patent application Ser. No. 17/898,025, entitled “Processing of Refuse Contamination Media Captured by Cameras, which was filed on Aug. 29, 2022, and is incorporated herein by reference in its entirety.

### TECHNICAL FIELD

The present embodiments are generally related to the field of waste management, and more particularly tracking of refuse dumping and collection methods. More particularly, embodiments are related to the use of several camera angles and artificial intelligence to capture, process and assess refuse contamination and fill-levels in private and commercial refuse containers, refuse collection vehicle hoppers, and/or dumping stations. Embodiments are also related to anonymous processing of refuse contamination in media captured by cameras using artificial intelligence.

### BACKGROUND

U.S. Pat. No. 7,870,042 B2 to Maruca et al, entitled “Systems and methods for identifying banned waste in a municipal solid waste environment”, is hereby incorporated by reference for its teaching. Waste management companies provide residential, commercial, and municipal waste management and recycling services for communities and organizations. Customers can range, for example, from single residences to entire towns or companies. Municipalities may contract with a waste management service provider to handle their municipal solid waste (MSW). MSW includes garbage, refuse, and other discarded material that result from residential, commercial, industrial, and community activities.

Commonly, in conjunction with the collection of refuse, a waste management service places waste containers for use at multiple customer sites. Waste container types that are utilized by customers are diverse in the industry and include, for example, residential or commercial large-volume metal or plastic containers such as dumpsters, roll-off containers, and rolling lift (or tip) carts.

Often, residential or commercial customers put waste other than MSW into a waste container. Such waste can generally be termed “banned waste” that must be disposed of properly in order to comply with local, state and/or federal laws and regulations. One type of banned waste is referred to as hazardous waste. As used herein, hazardous waste is a waste with properties that make it dangerous or potentially harmful to human health or the environment. The universe of hazardous wastes is large and diverse. Hazardous wastes can be liquids, solids, contained gases, or sludges. They can be the by-products of manufacturing processes or simply discarded commercial products, like cleaning fluids or pesticides.

In regulatory terms, a Resource Conservation and Recovery Act (RCRA) hazardous waste is a waste that appears on one of the four hazardous wastes lists (F-list, K-list, P-list, or U-list), or exhibits at least one of four characteristics—ignitability, corrosivity, reactivity, or toxicity. Hazardous waste is regulated under the RCRA Subtitle C.

Another type of banned waste referred to as “special waste” can include items such as household hazardous waste, bulky wastes (refrigerators, pieces of furniture, etc.) tires, and used oil. State and local governments regulate both hazardous and special waste to ensure proper transport and disposal. Generally, only properly permitted and regulated companies are authorized to remove and dispose of these types of waste.

Both hazardous and special wastes are also regulated by local and state governments to ensure, for example, that proper transport and disposal procedures are followed. Often, customers co-mingle banned waste with standard MSW. Generally, only properly permitted and regulated companies are authorized to remove and dispose of these types of waste. If a waste carrier picks up these banned waste items, either knowingly or unwittingly, the waste carrier may be violating of one or more operating permits and is subject to various penalties such as monetary fines and/or suspension of one or more permits.

Waste contamination is generally the presence of any substance that is not supposed to be in a particular waste stream. For example, solid waste in a recycling waste stream or an organic waste stream is contamination. Likewise, recyclable materials can be a contaminant in a solid waste stream or an organic waste stream. Organic materials can be a contaminant in a solid waste stream or a recycling waste stream.

Currently, the process for identifying banned waste is manual and, therefore, prone to error. Manual waste audits (aka “lid flipping”) typically only considers the first 30% or so of waste contained in a waste container. If collection vehicle personnel do not visually detect banned waste at the customer site, it can be inadvertently loaded onto the collection vehicle. The banned waste can then later be identified and removed at a transfer station or landfill. As a consequence, the waste company assumes the risk and is responsible for the proper disposal and associated costs for the banned waste. The waste company may not be able to pass these costs to the originating customer, because it is often impossible to identify the customer from which the banned waste was collected. However, banned waste sometimes also goes undetected throughout the entire collection, transport, and disposal process. This creates personnel safety implications, and the likelihood that the waste will end up in a landfill, which may eventually cause damage to the environment.

Therefore, a need exists for improvements to automatically identify banned waste during the MSW collection process. This can advantageously prevent banned waste from entering the MSW stream, and eliminate problems associated with subsequent disposal of this type of material. What is needed are methods and systems that can tie contamination events to a location, and which can do so in an automated fashion that provides necessary information to waste haulers and generators. Furthermore, the identification of contamination and fill-levels should be narrowly focused to collect the necessary information on contaminants and fill-levels without distributing information which may compromise the privacy of the waste generator.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

Throughout this disclosure, the term “refuse” also means “waste.” The terms “container” or “waste container” should be broadly interpreted to include private and commercial waste containers located at a premises, a hopper associated with a waste collection vehicle, and a containment area wherein collected waste can be inspected.

It is, therefore, one aspect of the disclosed embodiments to provide systems and methods for preventing banned waste from entering the MSW stream, and eliminate problems associated with subsequent disposal of this type of material.

It is another aspect of the disclosed embodiments to provide methods and systems that can tie contamination events to a location, and which can do so in an automated manner that includes privacy features such as obscuring portions of the image that are not necessary for assessing or demonstrating contamination.

In accordance with an embodiment, it is a feature to provide methods and system for identifying individual materials from waste streams. In one aspect of the disclosed embodiments, a request can be received from a requester utilizing an onboard edge device (“OED”) to assess waste contained in or obtained from a waste container. In another aspect of the disclosed embodiments, media in the form more than one of still images or video streams can be accessed from more than one camera in communication with the OED and located in association with at least one of a waste container, a collection vehicle, or an inspection area.

In accordance with another aspect of the disclosed embodiments, the media can be transmitted to an artificial intelligence (AI) platform for processing to determine the class of individual materials contained in the media and provide identification with a confidence level.

In accordance with another aspect the AI platform can be located with the OED at a waste collection vehicle and/or remotely in at least one network accessible server.

In accordance with another aspect of the disclosed embodiments, a data file containing processing results can be created.

In accordance with another aspect of the disclosed embodiments, a response can be generated and transmitted to the requester that initiated the request.

In accordance with yet another aspect of the disclosed embodiments, the response can include data that further includes all materials found by the AI platform as contained in the media with a confidence level for each and at least one of an identification of the requester, waste container identification, and waste container location.

It is a feature of the embodiments that a secondary camera can be used to identify the end-customer/generator utilizing the bin serial number or other identifying marks (e.g., bar codes, QR codes, etc.), as well as identifying status such as overflowing bins, bin signage, features (e.g., locks or enclosures), bin size and/or damaged bins. Identification of the bin to its account holder and any results of contamination can be matched in the system for additional fees, auditing the equipment on location matches what is billed, education, or preventative maintenance.

It is another feature that optical character recognition be utilized to identify waste containers/bins. Municipalities or haulers can assign serial numbers to specific waste generators (i.e., residents). Currently, many municipalities have serial numbers marked on bins, but very few of them have tied those to the identification of waste generators (i.e., Residents). An AI engine together with optical characters recognition can assist with the identifications of waste containers, obtaining updated status assessments for waste containers, and notifying operators of waste container status. AI combined, OCR, access to historical/status data and user interface (UI) operator notifications can assist with type of organization, identification, and processing.

It is a feature of the embodiments that an anonymity feature can be provided that can enable privacy of a residents'waste through a process of pairing a unique identifier with an account as well as blurring out any background that is not pertinent to an item of interest i.e., contamination.

It is a feature of the embodiments that an automated trigger event can be provided which captures photos or video for processing through AI models could be initiated by any one of: the initiation of the trash vehicles lifting arm; vehicle approaching a container/serviceable asset utilizing sensors; the point at which the waste vehicles arm is at its highest point and thus the contents are being dumped into the vehicles receiving area (hopper); any point within the trajectory of the arms engagement with the container; the scanning of an RFID tag; recognition of identifying marks on a bin i.e., serial number, address, QR code etc.; precise GEO coordinates (e.g. GPS or GNSS); detection of conditions from another AI Model.

It is a feature of the embodiments that a trigger of event(s) could be adjusted to ensure ideal timing for photo/video initiation. For example, there may be a gap in time between the arm of the waste vehicle reaching the top/end of its trajectory and all of the contents of the bin/container being emptied into the hopper.

It is a feature of the embodiments that the AI engine can be used to determine the number of bags contained in each individual pickup. This feature can be used for “pay as you throw” programs, which would charge a generator's account based on the actual amount of waste they dispose of. Furthermore, it is a feature of the embodiments that the AI model can be trained to differentiate between bags that are issued by a municipality or county and bags that are not. Whereas the municipalities could take some form of action on accounts that do not follow the municipal, hauler or other rules. In addition, the system could estimate volumes of waste versus volumes of recyclables to determine diversion on a per account basis. Furthermore, the identification of items in waste streams would allow the municipality or hauler to charge fees based on items that are not disposed of in bags and are in the correct waste stream. For example, it may be acceptable to dispose of an appliance, but there is a fee associated with the disposal of the item identified.

It is another feature of the embodiments to allow for the sequencing of lifts. This feature would be used to distinguish the contents of bin A from the contents from the subsequent lift of bin B. By using the photo(s)/video of bin A as a reference the AI would exclude items from that bin in the AI analysis of bin B.

It is a feature of the embodiments to enable a determination of fill level utilizing at least two cameras in association with a waste container. For example, the hopper associated with a waste collection vehicle can include at least two cameras disposed at two different locations and angles with respect to the hopper. Images from the at least two cameras can be assessed by AI to determine the fill level within the waste container. As another example, at least two cameras can be located in association with a residential or commercial waste container associated with a premises, wherein images obtained from the at least two cameras can be assessed by AI to determine fill level.

It is a feature of the embodiments to allow for the use of sensor (non-photographic or video) within a bin to measure other parameters of waste such as heat, chemical, radiation, biowaste, toxicity, etc.

These and other features will become apparent after reading the detailed specification and claims.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1, labeled as “prior art”, depicts a block diagram of a banned waste detection system.

FIG. 2, labeled as “prior art”, depicts an alternate exemplary block diagram of a banned waste detection system.

FIG. 3 illustrates a diagram for a system associated with a collection vehicle or waste container, in accordance with the embodiments;

FIG. 4 illustrates side and top perspectives of a hopper/bin associated with a collection vehicle, in accordance with the embodiments;

FIG. 5 illustrates a method for assessing waste within or obtained from a container, in accordance with the embodiments;

FIG. 6 illustrates another method for assessing waste within or obtained from a container, in accordance with the embodiments;

FIG. 7 illustrates an example of service locations and a method for service location optimization in accordance with an embodiment;

FIG. 8 illustrates a flow chart of operations depicting logical operational steps of a method for micro-geolocation verification, in accordance with an embodiment; and

FIG. 9 illustrates a diagram outlining features of micro-geolocation verification in the context of a collection scenario, in accordance with another embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part. In addition, identical reference numerals utilized herein with respect to the drawings can refer to identical or similar parts or components.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “waste container” or “container” as utilized herein can relate to, for example, residential waste containers or receptacles, which may include plastic, metal, or composite bins used in households or multi-unit dwellings to store garbage, recyclables, or organic waste until collection for disposal or processing. Such residential containers can include small indoor bins, such as kitchen or bathroom trash cans, and larger outdoor containers, such as curbside wheeled carts designed for automated or semi-automated collection systems.

The term “waste container” or “container” as utilized herein can also relate to commercial or industrial waste containers, including dumpsters, compactors, roll-off containers, and front-or rear-load bins, which are typically larger, more durable, and fabricated from heavy-duty materials such as reinforced steel or high-density polyethylene. These containers may be designed to accommodate greater waste volumes, varied waste compositions, or specialized disposal needs, including those associated with construction debris, manufacturing byproducts, food waste, or hazardous materials. In certain embodiments, the waste container may incorporate identifying features such as barcodes, RFID tags, embedded sensors, or color-coded markings to facilitate automated tracking, sorting, and processing of waste streams.

The term “materials” can relate to any matter or substance present within, on, or around a container, bin, or designated collection area. Materials can include, for example, overflow items that extend beyond the physical boundaries of a container or bin, or that spill onto surrounding surfaces, as well as debris, such as fragments, loose items, or residual matter located adjacent to, in front of, or alongside a container, bin, or collection receptacle. Examples of materials may include substances that contaminate a waste stream, as well as non-contaminating matter that may require detection, verification, or monitoring.

The term “generator” as utilized herein can relate to a waste generator, which may be, for example, a person, household, business, organization, or other entity that produces or originates or generates materials, waste, or recyclables. The generator (also referred to as a ‘waste generator’) is considered the source of the waste stream and may be associated with a specific location, address, or account. In certain embodiments, a generator can include, without limitation, an individual resident, a multi-unit dwelling occupant, a commercial establishment, an industrial facility, a municipality, or any entity responsible for disposing of materials into a waste container or other collection receptacle.

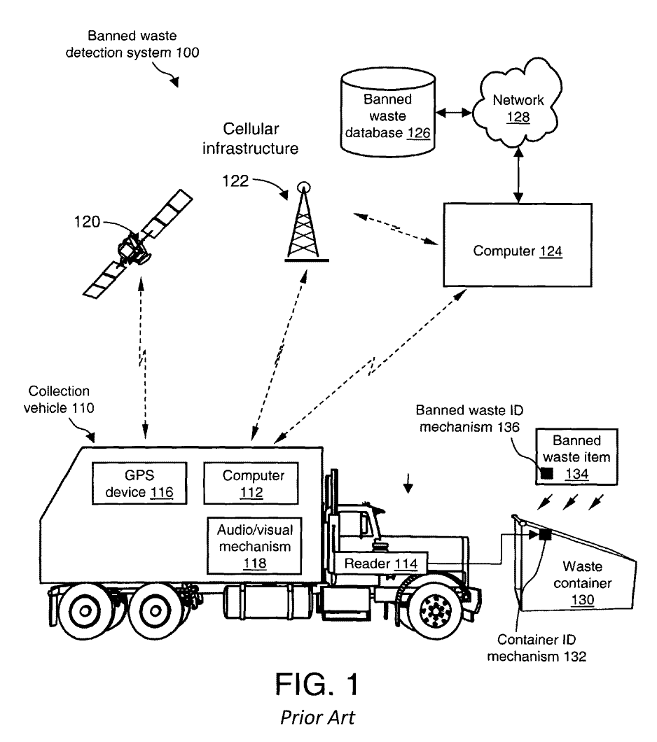

FIG. 1, labeled as “prior art”, illustrates an exemplary block diagram of a banned waste detection system 100 as described in non-limiting U.S. Pat. No. 7,870,042. Banned waste detection system 100 includes a collection vehicle 110 that further includes computer 112, reader 114, global positioning system (GPS) device 116, and audio/visual mechanism 118. Banned waste detection system 100 also includes GPS satellites 120, cellular infrastructure 122, computer 124, banned waste database 126, and network 128. Computer 124 and database 126 are connected via network 128. Additionally, banned waste detection system 100 includes waste container 130 that has a container identification (ID) mechanism 132 affixed thereon. Collection vehicle 110 can be, for example, one or more conventional waste hauling trucks that are used to collect refuse from a plurality of originator points.

Originator points can be, for example, commercial and industrial sites, residential curbsides, and/or community drop-off points. Computer 112 can be a standard laptop or desktop computer. Alternatively, computer 112 can be a mobile computing device that is integrated with collection vehicle 110. A non-limiting example of such an integral computer 112 is supplied by Glacier Computing (New Milford, Conn.) or by Mobile Computing Corp. Inc. (Mississauga, Ontario). Computer 112 can include industry standard components (not shown) such as a standard user interface and display, a processor, and a storage device. Storage device can be a hard disk drive or other suitable non-volatile storage.

Computer 112 also includes a clock device for providing timestamp data, and various standard interfaces such as universal serial bus (USB) for connecting to external devices. These devices may include, for example, reader 114, GPS device 116, and audio/visual mechanism 118. Wireless communication is provided using, for example, a standard modem and cellular infrastructure 122, and/or an IEEE 802.11 wireless link. The wireless communication link allows computer 112 to communicate with computer 124 in various ways. Reader 114 is a commercially available RFID tag reader system, such as the TI RFID system, manufactured by Texas Instruments Incorporated (Dallas, Texas). GPS device 116 is a standard global positioning system that supplies position data, such as digital latitude and longitude.

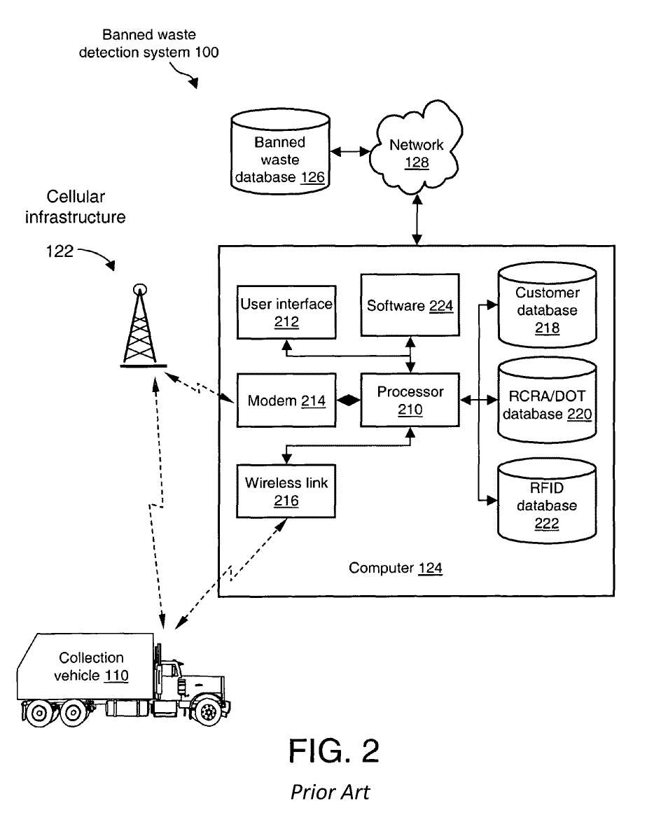

The GEOTAB GPS system is a commercially available vehicle fleet and productivity management system, manufactured by GEOTAB (Burlington, Ontario, Canada), that can be utilized. Audio/visual mechanism 118 may be, for example, a buzzer, beeper, tone, and/or flashing light emitting diode (LED), that notifies collection vehicle 110 pickup personnel that reader 114 has detected banned waste item 134 via banned waste ID mechanism 136. Audio/visual mechanism 118 can be implemented on computer 112 using its visual display and/or the audio capabilities. GPS satellites 120 provide location data to GPS device 116 in a conventional manner. Cellular infrastructure 122 includes a plurality of cell towers and other cellular network interconnections (not shown), as is well known. Computer 124 can be, for example, any standard laptop or desktop computer, as is described in connection with FIG. 2.

Banned waste database 126 can be a standard database, which can be a collection of data related to identifying types of materials, also containing general guidelines concerning the handling thereof. An example of such a database is the CHEMLIST® database, available from CAS Databases (Columbus, Ohio). Waste container 130 can be any commonly used, large-volume receptacle, such as a dumpster, a roll-off container, or a 90-gallon toter that is used for residential curbside collection. Container ID mechanism 132 can be, for example, an RFID tag or bar code that allows waste container 130 to be uniquely identified.

Container ID mechanism 132 can be scanned by reader 114, in order to extract the identification number thereon. When container ID mechanism 132 is read by reader 114, the RFID data can be transmitted to computer 112 and subsequently transmitted to computer 124. The reading of container ID mechanism 132 allows customer database 218 (FIG. 2) to determine the customer (or owner) associated with the banned waste item 134 and/or record the time that the banned waste item 134 was detected. Banned waste item 134 is a waste item that a waste management company is typically prohibited from collecting, or that may require special handling procedures. For example, banned waste 134 could be either hazardous and/or special waste that must be disposed of properly in order to comply with local, state, and federal laws and/or regulations. Banned waste ID mechanism 136 is, for example, a RFID tag, or other identifier such as a barcode, that provides identification data electronically to reader 114.

Banned waste ID mechanism 136 may contain Resource Conservation and Recovery Act (RCRA) data that allows reader 114 to detect and determine that banned waste item 134 is hazardous. The RCRA data includes procedures that are to be used in treating, transporting, storing, and disposing of hazardous wastes. This information can be displayed by or in connection with computer 112. By use of banned waste ID mechanism 136, banned waste item 134 can be identified and separated, so as not to co-mingle with the MSW stream. If banned waste 134 is detected, there several different courses of actions that might be taken. For example, if the banned waste 134 can be visually identified and removed, the customer may be notified. In addition, waste container 130 may be quarantined and an inspector may be summoned to inspect the waste container 130. The banned waste may also, if appropriate, be collected by collection vehicle 110.

FIG. 2 is an exemplary block diagram of a banned waste detection system 100, in accordance with an embodiment of the present invention. Computer 124 includes standard components such as processor 210, user interface 212, modem 214, and wireless link 216. Computer 124 also contains, or utilizes one or more databases such as customer database 218, a Resource Conservation and Recovery Act/Department of Transportation (RCRA/DOT) database 220, and RFID database 222. Processor 210 can be a standard general-purpose microprocessor, such as a Pentium or a PowerPC microprocessor device. User interface 212 can be a standard computer user interface for inputting and displaying data, such as a keyboard, mouse, or touch screen with accompanying menus and prompts. Modem 214 can be a standard wireless modem manufactured, for example, by CYNET Incorporated (Houston, Tex.). Wireless link 216 can be a standard interface that communicates using one or more wireless data communications links. Long range data links such as a Code Division Multiple Access (CDMA) 1×EV-DO or General Packet Radio Service (GPRS) link may be used. Short range wireless links such as IEEE 802.11 may also be used.

Customer database 218, RCRA/DOT database 220, and RFID database 222 are standard data repositories, or databases. The information stored in these repositories can be stored on a single medium and/or have their contents combined. Repositories 218, 220, 222 can be implemented in any manner that facilitates storage, access to, and/or retrieval of data. More particularly, customer database 218 may contain, for example, data fields and associated data pertaining to customer name, billing address, service address, frequency of service, account/payment/billing status, and service address GPS coordinates.

RCRA/DOT database 220 can contain a collection of data and information associated with the identification, collection, and management of hazardous and/or special waste, according to RCRA/DOT requirements, which may include federal, state, and/or local regulatory information that pertains to banned waste. For example, RCRA/DOT database 220 can include the following example information: i) a solid waste that exhibits that characteristic of ignitability has the EPA Hazardous Waste Number of D001; ii) a solid waste that exhibits the characteristic of corrosivity has the EPA Hazardous Waste Number of D002; iii) a solid waste that exhibits the characteristic of reactivity has the EPA Hazardous Waste Number of D003; iv) a solid waste exhibits the characteristic of toxicity can have an EPA Hazardous Waste Number of D004 through D043. In addition to the D series above, the EPA also has an “F” Series, a “K” series, a “P” and a “U” series, as previously noted. RCRA/DOT database 220 also includes data such as safe and secure procedures that are to be used in treating, transporting, storing, and disposing of hazardous wastes.

RFID database 222 can contain a record of items that may include banned waste items. For example, RFID database 222 contains a record of the specific RFID data associated with glass containers, plastic containers, aluminum containers, paper products, as well as banned waste items 134. As the reader 114 scans mechanisms 136, computer 112 may keep a rolling tally (e.g., an inventory) of items 134 that are collected by vehicle 110. Customer database 218, RCRA/DOT database 220, and RFID database 222 can reside in a memory device (not shown), such as a hard disk drive of computer 124. In another embodiment, one or more of repositories 218, 220, 222 may also reside on collection vehicle 110, on a storage medium (not shown) used in connection with computer 112. The contents of customer database 218, RCRA/DOT database 220, and RFID database 222 may be organized and combined in any user-defined relational or non-relational database structure.

Software 224 analyzes data received from reader 114. For example, software 224 can cross-reference, as appropriate, the ID data received from mechanisms 132 and 136, via collection vehicle 110, to customer database 218, RCRA/DOT database 220 and/or RFID database 222. In doing so, software 224 determines the customer from mechanism 132 using customer database 218, and the type of each waste item 134 from mechanism 136 using RCRA/DOT database 220 and/or RFID database 222. Software 224 can identify any banned waste 134 that has been co-mingled in waste container 130, but only from a single perspective thereby impacting accuracy. In operation, collection vehicle 110 arrives at a pick-up location and engages waste container 130 and reads container ID mechanism 132.

The main limitation to prior art processes is in the image acquisition and assessment of media. Current systems are not acquiring enough actual images to have high confidence level. Additionally, customer may not be willing to provide media if they will not be able to obtain immediate results. These challenges can be overcome with the use of multiple camera angles being input into media files that can then be provided for remote assessment utilizing machine learning and artificial intelligence (AI) models.

What is needed is an artificial intelligence-based system that learns what contaminates to look for. In accordance with the embodiments, large amounts of tagged images within a database can be provided to train an AI model to compare with materials in question during real time analysis. Ongoing learning of contaminates by an AI system can overcome obstacles in identifying waste.

In some implementations, machine learning or artificial intelligence (AI) models can be employed to recognize identifiers or contextual features from sensor data or imagery, thereby enhancing micro-geolocation verification accuracy under variable lighting, weather, or environmental conditions. Note that for the purposes of this disclosure, the term “AI model” can relate to a computational system or algorithm trained to identify patterns, make predictions, or perform classification tasks based on input data. Examples of AI models that may be used include convolutional neural networks (CNNs) for image recognition and recurrent neural networks (RNNs) for sequential or temporal data analysis. In some embodiments, for example, hybrid AI approaches combining CNNs and RNNs may be utilized, allowing the system to simultaneously process spatial image data and temporal patterns, such as changes in object positioning or service event sequences, to improve micro-geolocation verification reliability.

In the context of waste collection or delivery services, a hybrid AI model combining CNNs and RNNs may be employed to enhance micro-geolocation verification. For example, a CNN can analyze images captured by vehicle-mounted or stationary cameras to identify visual features of waste bins, parcels, or delivery locations, such as barcodes, serial numbers, or distinctive container shapes. Simultaneously, an RNN can process sequential data, such as time-stamped sensor readings, GPS coordinates, or the order in which collection points are visited, to detect patterns or anomalies in service execution. By integrating spatial recognition from the CNN with temporal and sequence analysis from the RNN, the hybrid AI model can determine with high confidence whether a service event occurred at the correct micro-geolocation, flagging potential discrepancies and providing actionable verification data.

Currently, cameras deployed in a limited fashion are used to take pictures or stream a live feed of the materials being dumped into a truck where they are evaluated by either the person in the truck or a person who manually analyzes the data to determine if contaminates are present. In this model there is no way to determine volume in a unified way. Alternatively, AI technology can create automation wherein the media can be processed remotely (i.e., in the cloud) without human intervention. A machine derived confidence level and volume of content can also be calculated using the system and methods disclosed herein.

Note that one or more cameras may be deployed in the context of different embodiments. That is, as utilized herein, references to the use of cameras or imaging devices are not intended to require any minimum number of cameras unless explicitly stated. In some embodiments, a group of cameras can be employed to capture complementary views useful for identifying contamination within a waste container, such as a combination of a dash-mounted camera and a hopper camera on a front-end-loader (FEL) vehicle, or a side-mounted camera and a hopper camera on an automated side-loader (ASL) vehicle. These multi-camera configurations can improve the accuracy of contamination detection by enabling image capture from different vantage points.

However, in other embodiments, such as when detecting overflow or debris around the exterior of the container, only a single camera may be required. For example, a single forward-facing camera on FEL, ASL, or rear-loader (RL) vehicles may provide sufficient field of view to detect overflow conditions, fallen bags, or material extending beyond the container boundaries. Accordingly, the systems and methods described herein may operate with one camera, two cameras, or any number of cameras appropriate for the particular detection task, vehicle configuration, or operational environment, and should not be limited to embodiments requiring a plurality of cameras.

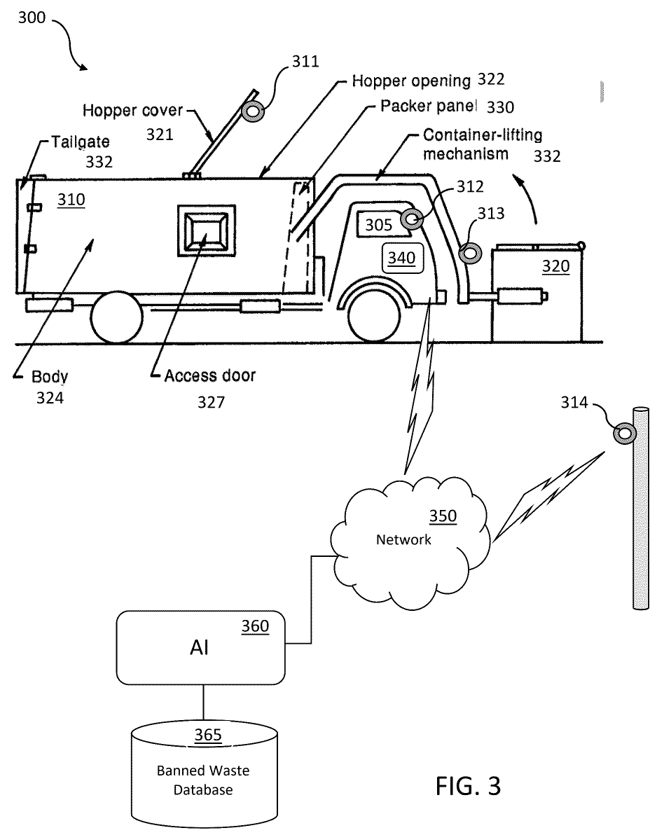

Referring to FIG. 3, a system 300 that can be provided and used to identify individual materials from waste streams utilizing still images or video streams is illustrated. Images/video streams can come from a camera(s) 311, 312, 313 mounted to the collection vehicle 310, a camera 314 mounted external to a waste container 320 or in a waste container 320 and transmit media over a network 350 to an AI platform 360 for processing. An AI platform 360 including a banned waste database 365 that can determine individual material(s) contained in the image(s) and provide a confidence level. Once media is processed, a response can be generated by the AI platform 360 and passed to the entity that initiated the request (or other configured system).

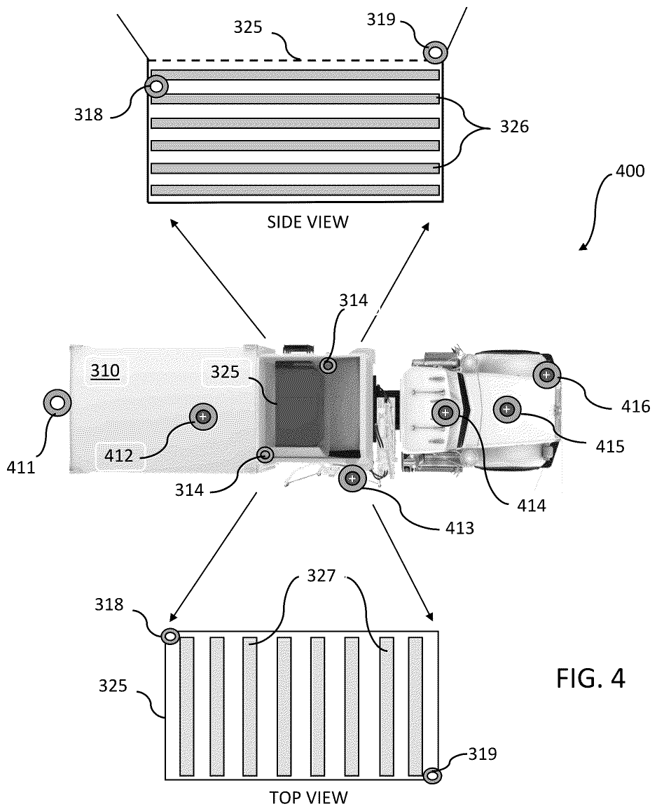

The response can include (but not limited to) any of an identifier of the request, all materials found by the AI platform 360 that is contained in the media with a confidence level for each, and other custom configured pass-through data (e.g., lat-long, RFID). The images combined with AI platform 360 processing could also be used to determine the volume of material in the media. This could be used for a variety of purposes such as billing, service optimization, etc. This can be termed “Pay as you throw” which means the hauler bills based on the amount, volume, quantity, or weight of materials picked up. Also shown in FIG. 3 are features typically provided in association with a collection vehicle 310, including a hopper cover 321 wherein waste is dumped into a hopper opening 322, a tailgate 323 wherefrom waste is removed from the body 324 of the collection vehicle 310 wherein the waste has been compacted and stored, an access door 327 providing access to the hopper 325 shown in FIG. 4, a packer panel 330, that compresses waste within the hopper, and a container-lifting mechanism 332 that lifts the container 320 over the cab 305 and dumps waste into the hopper via the hopper opening 322.

Data in the form of images that are acquired by cameras can undergo preliminary processing and storage in an onboard edge device 340 mounted in the collection vehicle 310. An onboard edge device 340 (“OED”) can also be mounted in the waste collection vehicle 310 programmed to run an AI program thereby avoiding the inference costs of running data in real-time through cloud server infrastructure and incurring cellular network costs. This can assure that only pictures of contaminates can be sent to the AI Platform 360 over the data network 350 for further assessment/validation. If no evidence of contamination is found, a text verifying such can be sent to the remote AI platform 360.

Optical character recognition (OCR) can be utilized as software in the OED 340 to identify waste containers/bins. Municipalities or haulers can assign serial numbers to specific waste generators (e.g., residents). Currently, many municipalities have serial numbers marked on waste containers (e.g., bins) 320, but very few of them are tied to the identification of waste generators (i.e., residents, commercial operations). An AI engine 360 together with optical characters recognition can assist with the identification of waste containers, obtaining updated status assessments for waste containers from a such as banned waste database 365, and notifying operators of waste container status on a user interface 212 in the cab 305 (such as a touch sensitive screen). AI combined, OCR, access to historical/status data from a database and a user interface (UI) to provide operator notifications can assist with type of organization, identification, and processing.

Note that the term “engine” as utilized herein can relate to software, hardware, or a combination of software and hardware component configured to perform one or more operations, steps, or functions as described in the disclosed embodiments. An engine may include, without limitation, a program module, application, routine, or other executable component capable of being executed by a single computer, a group of computers, or a distributed computing environment such as a cloud-based or edge-computing system. The engine may operate locally, remotely, or in a hybrid configuration to carry out the functionality described herein.

The term “AI engine” as utilized herein can relate to an engine that employs artificial intelligence, machine learning, or other computational models to process, analyze, or interpret data. An AI engine may include, without limitation, algorithms, models, or neural networks configured to identify patterns, classify materials, detect contaminants, predict outcomes, or otherwise perform automated or semi-automated decision-making tasks. The AI engine can operate locally, remotely, or in a distributed environment, and may utilize input from one or more sensors, media data, or databases to perform its functions.

The term “AI platform” as utilized herein can relate to a computing system, framework, or environment that can host, coordinate, or provide access to one or more AI engines for performing processing, analysis, or interpretation of data. An AI platform may include, without limitation, hardware, software, or a combination thereof, and may operate in, for example, a cloud-based, edge-based, or hybrid distributed environment. The AI platform can provide standardized interfaces, data management, orchestration, and deployment capabilities, enabling multiple AI engines to execute tasks such as classification, detection, prediction, or decision-making, and to integrate with other system components, sensors, or databases as described in the embodiments.

Referring to FIG. 4, illustrated is a diagram 400 with side and top perspectives of a hopper/bin that can be associated with a collection vehicle 310 as described in FIG. 3, in accordance with the embodiments. The hopper 325 can include stripe markings 326 on its sides to indicate fill level for at least two cameras 318 and 319 located within, or in association with, the hopper 325. The hopper 325 can also include stripe markings 327 on its bottom to further indicate fill level to the at least two cameras 318/319. Also shown in FIG. 4 is the example inclusion of several other cameras 411-416 that can be located (mounted) throughout the collection vehicle 310 to provide additional perspectives of waste collection operations.

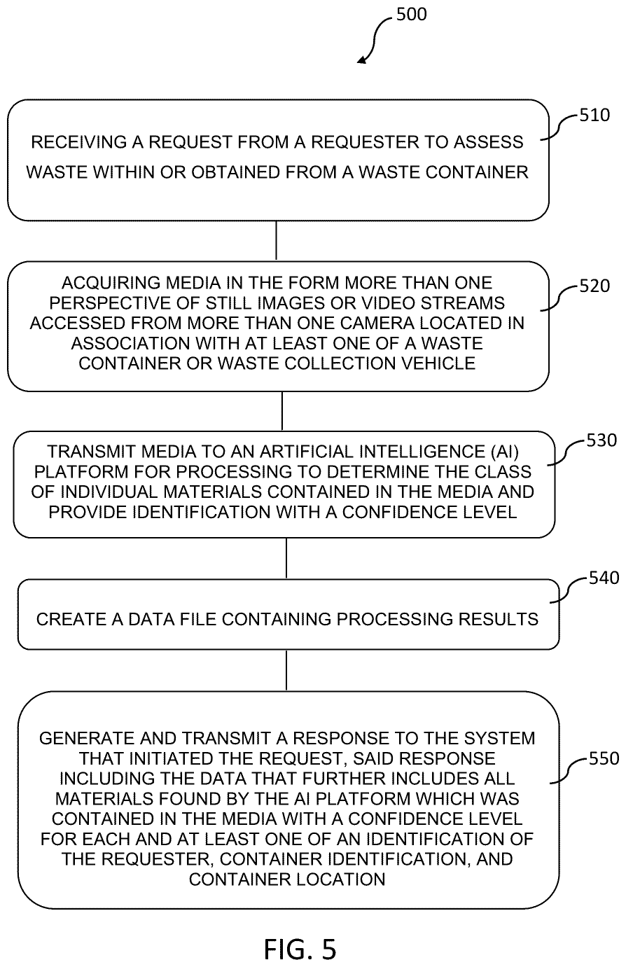

Referring to FIG. 5, a flow diagram 500 of method in accordance with the embodiments is illustrated. Referring to block 510, a request from a requester can be received to assess waste within or obtained from a waste container. Referring to block 520, media in the form of more than one perspective of still image or video streams can be acquired and assesses from more than one camera located in association with at least one of a waste container or waste collection vehicle. As shown in block 530, the media can be transmitted to an artificial intelligence (AI) platform for processing to determine the class of individual materials contained in the media and provide an identification with a confidence level. A data file containing processing results can be created, as shown in block 540. Then, as shown in block 550, a response can be generated and transmitted to the system that initiated the request. The response can include the data that further includes all materials found by the AI platform which was contained I the media with a confidence level for each and at least one of an identification of the requester, container identification, and container location.

Note that the term ‘requester’ as utilized herein can relate to any person, organization, system, or entity that initiates or submits a request associated with a service event, operational task, or data exchange described herein. A requester may include, for example, an individual user, a customer, a service provider, a third-party platform, or an automated system that generates a request based on predefined rules or detected conditions. In a waste-collection scenario, the requester may be a hauler initiating a service verification request, a municipality or property manager seeking confirmation of service completion, or an automated dispatch or routing system generating a pick-up request based on schedule, sensor data, or container status. More generally, the requester can be any initiating source responsible for triggering a workflow, operation, or data retrieval within the systems and methods described herein.

The information from these embodiments can be used to improve reporting the quality of materials picked up at a granular level for recycling purposes and help to ensure landfills are not being burdened with non-environmentally friendly materials. The granularity would make it possible to identify the actual offenders of contamination, whereas previously it is not possible given the number of collections that occur in an individual route. This technology in some form does exist in Australia but in the United States of America it appears to be a manual process where the driver of the vehicle has a monitor in the cab and verifies contaminates by looking at the image on the monitor.

Waste operators including private or public hauling organizations would use this technology to have a better understanding of the behavior of its generators. Including but not limited to the volume generated, type of material in each individual stream, adherence to regulations of acceptable material in a stream. This would help operators with billing, fees, and possibly suspension of service. Waste Consultants, municipalities, large organizations with sustainability or Environmental, Social, and Governance (ESG) initiatives would also find benefits in this technology in a similar way. The use of an AI engine to automatically track the volume and character of waste disposal is highly valuable to an ESG program which is focused on measuring the amount of waste generation and the diversion rates of specific waste streams such as multiple types of recycling and organic waste.

The disclosed embodiments allow for media data, including a still image, a group of images, or video data, to be acquired, analyzed, and processed by an AI engine or a combination of AI engines hosted on an AI platform in an automated and consistent manner, thereby reducing or eliminating human interpretation or error. By leveraging one or more AI engines, the system can automatically identify materials, detect contaminants, and classify waste without requiring manual intervention, thereby providing time savings by reducing labor required for material assessment and reducing human error associated with misidentification or failure to flag contaminants.

Additional benefits of the embodiments include lowering costs associated with media processing and contamination analysis, streamlining operational workflows, and standardizing results across multiple collection sites, waste containers, and generators. The AI platform may implement machine rules or algorithms that are preconfigured or dynamically updated to comply with applicable laws, regulations, or policy objectives, ensuring consistent evaluation and reporting of waste across time, locations, and originators.

By improving accuracy and consistency in waste material identification, the system helps prevent contaminants from entering landfills, thereby contributing to environmental protection, including reductions in methane emissions and greenhouse gas output. In certain embodiments, the AI platform may operate in a distributed or hybrid configuration, such as a combination of onboard edge devices and cloud computing, to optimize processing efficiency, reduce data transmission requirements, and maintain privacy protections for non-relevant portions of the media data. Collectively, these embodiments provide a technologically enhanced, efficient, and environmentally beneficial solution for automated waste material assessment and management.

California recently passed legislation that no longer permits organics/food waste to be discarded in solid waste or recycling bins. This technology could be used to enforce this new recycling program which in turn will decrease the amount methane and Co2 being released into the atmosphere. Further, there are several other states that have passed similar legislation including, for example, New Jersey, New York, Connecticut, Vermont, Rhode Island, and Washington.

By improving data collection, assessment and information flow, collection service providers and residents can be provided with the information they need, thereby making waste service more efficient. Using advanced technology, such as artificial intelligence, radio frequency identification (RFID) tags, GPS tracking, garbage truck cameras, and supplementary camera input, can provide interested parties with up to-date information, information that can be provided in an anonymous or private manner, and which can overall improve the experience around waste management services.

The presence of a contaminant in a receptacle can be documented via the AI technology wherein the requester/hauler can choose to educate or warn waste generators or levy a fine to the generator in accordance with applicable laws or ordinances. However, in addition to a fine a hauler might choose to stop service for waste generator, provide educational information to waste generator, and or warn the waste generator of the infraction.

Privacy will undoubtably become an issue in the use of AI detection of generators/individuals waste items. We have the ability and will implement the blurring of all items other than those deemed contaminants. We believe this will be important to all parties as to limit exposure and liability of infringing on privacy rights.

Some municipalities manually audit waste and recyclables, from time to time, to determine the quantities of different disposed items i.e., the amount and/or percentage of waste that is bottles, cans, plastic bottles, cardboard etc. These audits can be automated using the AI platform described herein. The AI engine is able to collect data on the quantities of each item thereby eliminating the need for manual audits.

The EPA administers the Renewable Fuel Standard (RFS). As a part of RFS, Renewable Identification Numbers (RINs) are generated when a waste material is recycled to make a renewable fuel. For example, there are Used Cooking Oil (UCO) recyclers that take used oil from restaurants and others that use cooking oil. The haulers pick up the UCO and deliver it to aggregators or a processing plant that takes the UCO and transforms it into renewable fuel—each gallon collected enables them to generate a RIN. Likewise, haulers of organic waste collect organic waste and drop it off at “waste to energy” plants that convert the organic waste to biogas. This too enables generation of a RIN. Large oil companies (e.g., Shell, Exxon, etc.) are required by the government to purchase a certain number of RINs for every 100 gallons of gas sold—e.g., approximately 2 biodiesel RINs (e.g., cooking oil) for every 100 gallons of gasoline sold in the United States.

To protect against fraud, CPA firms are being asked to do an attestation audit to confirm that RINs are legitimate. When the RINs are audited and the CPA firm attests to their legitimacy, the RINs become Q-RINs. As part of its regulatory oversight, the EPA requires that the CPA firms “trace” the recycled oil and organic waste, as applicable, back to its source. Employment of sensor technologies (e.g., cameras) and AI as described herein can enable the provision of granular details about the day/time, location, and amount of the waste picked up, and can assist in the tracking of RIN qualified waste back to its source.

The AI platform can be trained prior to assessment using cross model analysis wherein the AI platform is trained with at least one of example media which are manually tagged or synthetic data. 3D images and synthetic data examples of media that is contaminated or not contaminated can be utilized in training the AI platform. Training can also include utilization of optical character recognition via the cameras(s) to identify waste containers/bins as mentioned herein before.

The AI platform can be deployed via an onboard edge device 340 to run the AI program thereby avoiding the inference costs of running in the cloud and cellular network costs as only pictures of contaminates will be sent to the cloud. If no evidence of contamination is found text verifying such will be sent to the cloud. This can create the opportunity for at least two categories of processing, one-board (i.e., at the waste collection vehicle) and remote (i.e., in the cloud/remote server).

The AI platform can be trained prior to assessment using cross-model analysis, wherein the platform is provided with at least one form of example media, including manually tagged media, synthetic data, or combinations thereof. Such training data can include 2D images, 3D images, or video sequences representing waste that is contaminated or non-contaminated, enabling the AI platform to learn to distinguish between different material types, identify contaminants, and classify waste streams with high accuracy. In certain embodiments, training may further incorporate optical character recognition (OCR) or other computer vision techniques to identify waste containers or bins, as previously described, providing the AI platform with the ability to correlate detected materials with specific containers, addresses, or generators

In some embodiments, the AI platform may be deployed on an onboard edge device associated with a waste collection system, allowing the AI program to run locally at or near the point of collection. This edge deployment reduces the need for continuous data transmission to a cloud server, thereby avoiding inference costs associated with remote cloud processing and minimizing cellular or network usage. In these configurations, only media or images that indicate potential contamination are transmitted to the cloud for further verification or archival, while non-contaminated media may be summarized in textual or metadata form and sent to the cloud, conserving bandwidth and processing resources. This architecture enables at least two modes of processing: local, onboard processing for preliminary or real-time assessment, and remote cloud-based processing for more detailed analysis, cross-validation, or aggregation of data across multiple collection sites or vehicles. By combining edge and cloud processing, the system can optimize computational efficiency, reduce latency in contaminant detection, and maintain high accuracy in waste identification and reporting.

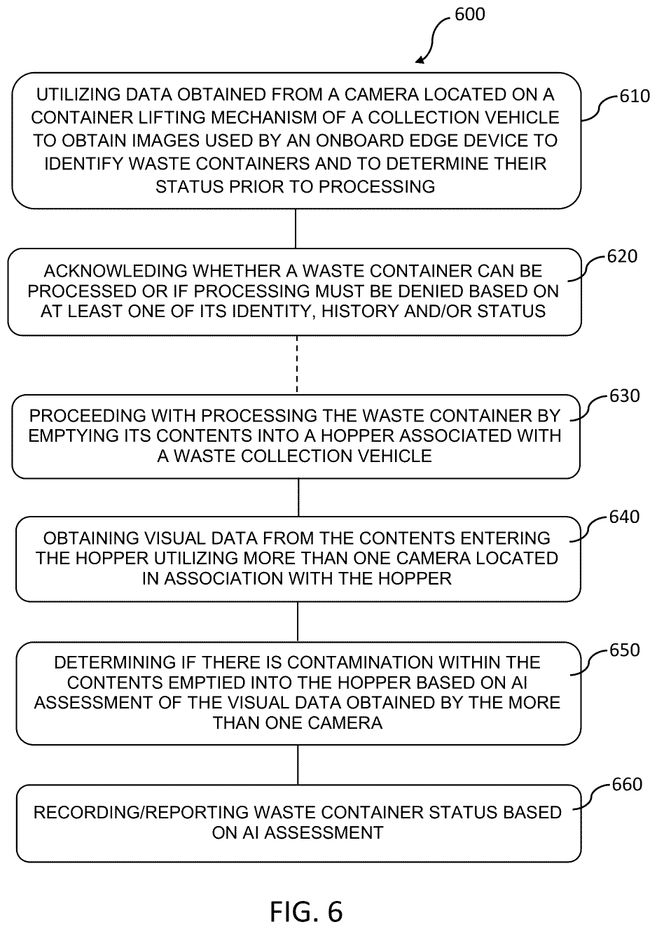

Referring to FIG. 6, illustrated is another flow diagram of a method 600 that can be carried out in accordance with the embodiments. Referring to block 610, data obtained from a camera located on a container lifting mechanism of a collection vehicle can be utilized by an onboard edge device (OED) to obtain images used identify waste containers and to determine their status prior to processing. Referring to block 620, It can be acknowledged based on the OED's assessment whether a waste container can be processed or if processing must be denied based on at least one of its identity, history and/or status. Identity can be based on its listing obtained from a database of banned or suspended waste containers. History can indicate prior violations/outstanding violation issues for a waste container based on its listing in data obtained from a database. Status can be based on database history or on a real-time condition as assessed by the camera, such as an overflowing condition.

As shown in block 630, a collection vehicle can proceed with processing a waste container by emptying its contents into a hopper associated with the collection vehicle, if it passes the initial assessment outlined in steps 610-620. Visual data from the contents entering the hopper can be obtained utilizing more than one camera located in association with the hopper, as shown in block 640. As shown in block 650, it can be determined if there is contamination within the contents emptied into the hopper based on AI assessment of the visual data obtained by the more than one camera. It should be appreciated that the assessment can be conducted preliminarily by the OED in order to conserve on data communications resources. If the OED assessment determines that contamination of waste obtained from the waste container may exists, a more thorough AI assessment can occur remotely with images provided via data network communications to a remote AI platform.

Then as shown in block 660, status of the waste container is recorded/reported based on results of the AI assessment. This status can be recorded in a data base (i.e., such as database 365). The data can also be reported to the operator (e.g., at the OED 340). The response can include the data that further includes all materials found by the AI platform which was contained in the media with a confidence level for each and at least one of an identification of the requester, container identification, and container location. The result of assessment can be utilized to, for example, initiate a “flag waste generator” condition and/or a “stop service” condition. Other conditions are possible.

Referring now to FIG. 7, illustrated is an example of service locations and a method for service location optimization in accordance with an embodiment. In conventional systems, a geolocation for a service address, such as a residential or commercial property, is typically obtained from publicly available mapping services. These services commonly associate latitude and longitude coordinates with a central point of the building structure, such as the center of the roof. This position is represented in FIG. 7 by a first pin.

While this conventional geolocation provides a general indication of property location, it does not accurately reflect the physical point at which waste collection or service activity occurs. For example, a waste container may be placed for collection along a curbside, alley, or designated pickup area that is offset from the building's centroid by several meters or more. As a result, collection verification, route optimization, and service recordkeeping can be less precise when based solely on conventional mapping coordinates.

In certain embodiments, the invention introduces an optimized service location represented in FIG. 7 by a second pin. This optimized location is determined by correlating actual sensor or media data captured during collection, such as camera images, RFID reads, or GPS data from collection equipment, with the corresponding service address. The optimized service location represents the actual physical location at which a waste container is serviced, rather than the estimated location derived from third-party mapping sources.

By associating the optimized service location with the corresponding address, the system can improve service verification and collection accuracy. This correlation enables verification that a waste container was serviced at its true location, provides more accurate route validation, and enhances auditing of completed collections. Additionally, the optimization process can refine mapping data over time, automatically adjusting default geolocation data for future service events based on recorded collection activity.

The service location optimization method can be integrated with other features described herein. For example, when media data of a serviced waste container is acquired and processed to identify materials or contaminants, the optimized location can be stored in association with the processed data file, thereby linking visual or sensor-based waste assessments with precise spatial metadata. In certain embodiments, optimized service locations can further support compliance with municipal collection contracts, reduce disputes regarding missed pickups, and improve operational analytics across a fleet of collection systems.

Accordingly, the embodiment illustrated in FIG. 7 demonstrates how the invention extends beyond waste material identification to encompass spatial accuracy and operational optimization, providing a verified, data-driven approach to waste service management.

The embodiment shown in FIG. 7 thus involves the precise geolocation of waste collection bins to improve service verification and operational accuracy. Conventional geolocation data obtained from mapping services typically places a location coordinate over a central point of a building, such as the center of the roof, which may not correspond to the actual point where a bin is placed or collected. The disclosed method optimizes this standard geolocation by recording the actual location at which a waste container is serviced, based on GPS data, sensor inputs, or camera-based measurements obtained during collection. This optimized location is then associated with the corresponding address or generator, providing a verified service location that more accurately reflects the point of collection. By correlating the collection bin's precise geolocation with media data and container identification, the system enables improved verification of completed collections, enhances route tracking, supports operational audits, and provides a reliable record of service for compliance, billing, or reporting purposes.

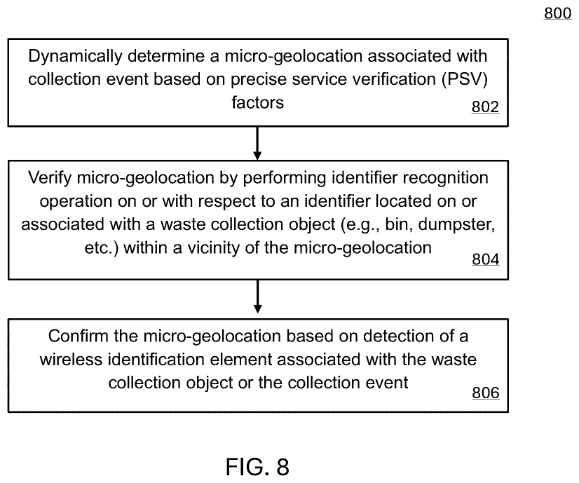

FIG. 8 illustrates a flow chart of operations depicting logical operational steps of a method 800 for micro-geolocation verification in the context of waste collection, in accordance with an embodiment. As shown at block 802, a step or operation can be implemented for dynamically determining a micro-geolocation associated with a collection event based on precise service verification (PSV) factors, which may include service experience data, client input, or information obtained from sensors deployed on collection vehicles or personnel. The PSV factors may be continuously or periodically evaluated to identify a precise location associated with a service task, such as curbside waste collection, recycling, compost, hazardous waste pickup, or industrial container servicing. This step ensures that the collection event is tied to a verified micro-location, rather than relying solely on approximate property-level geolocation.

As indicated at block 804, a step or operation can be implemented for verifying the micro-geolocation by performing an identifier recognition operation on an identifier located on or associated with a waste collection object, such as a residential or commercial bin, dumpster, or industrial container, within the vicinity of the micro-geolocation (e.g., curbside, driveway, or designated pickup zone). The identifier recognition operation may utilize one or more optical, electronic, or network-based techniques to detect and decode the identifier that uniquely corresponds to the physical object or property feature, enabling precise confirmation that the correct item is being serviced.

Next, as indicated at block 806, a step or operation can be implemented for confirming the micro-geolocation based on detection of a wireless identification element associated with the waste collection object or the collection event. This cross-verification can complement the identifier recognition operation and helps improve the reliability and precision of the micro-geolocation determination. Wireless identification elements may include RFID tags, near-field communication (NFC) devices, Bluetooth beacons, wireless transponders, or other wireless identifiers, allowing verification even in low-light conditions or where visual identification is partially obstructed.

In some embodiments, the identifier recognition operation in block 804 may involve optical character recognition (OCR); however, other recognition techniques may also be employed. These include barcode or QR code decoding, alphanumeric symbol recognition, symbol or pattern analysis, digital watermark decoding, network-based identifier verification, or blockchain/cryptographic identifiers. In addition, electronic or embedded identifiers such as magnetic strips, chip-based identifiers, or RF/inductive signatures may be used, as well as non-optical techniques like acoustic signature analysis, vibration pattern recognition, or thermal pattern identification. These diverse methods enable verification in complex waste collection environments, such as multi-tenant properties, industrial sites, or locations with obstructed bins.

The identifier may comprise a serial number, alphanumeric code, or other character sequence displayed on or affixed to the waste collection object. It may be printed, engraved, embossed, or otherwise presented on the surface such that it is detectable by a camera, imaging sensor, or other sensing device. By verifying this identifier, the system ensures that the correct object at the precise micro-geolocation is serviced and accurately recorded.

Note that the term “sensor” as utilized herein can include a variety of different types of sensors, sensing devices, modules, or components capable of detecting, capturing, or measuring physical, environmental, positional, or operational conditions associated with a service event or surrounding environment. For example, a sensor may be a camera configured to capture still images or video; an optical sensor; an infrared or thermal sensor; an ultrasonic sensor; a depth or LiDAR sensor capable of generating three-dimensional data; a proximity or range-finding sensor; a weight or load sensor; a vibration or motion sensor; an accelerometer; a gyroscope; a GPS or other geolocation sensor; an ambient light sensor; or an environmental sensor for detecting temperature, humidity, air quality, or other atmospheric conditions. Additionally, sensors may include RFID readers, barcode or QR code scanners, NFC readers, chemical or material-composition sensors, or any other device capable of generating sensor data used by the systems and methods described herein. Sensors can be integrated into a vehicle, a handheld device, a stationary structure, or an autonomous platform, and may operate individually or in combination to provide multi-modal data inputs for processing and analysis.

During confirmation at block 806, detection of the wireless identification element allows for redundancy and hybrid verification. For example, a Bluetooth beacon attached to a bin can broadcast a signal confirming the presence of a collection vehicle at the correct micro-location. Similarly, an NFC tag may be scanned to record service completion, while an RFID tag can passively transmit a unique identifier for verification. By combining identifier recognition (e.g., see block 804) and wireless detection (e.g., see block 806), the method 800 can achieve high-confidence verification of waste collection events at the micro-geolocation level, providing an auditable record for operational management, billing, regulatory compliance, or service performance tracking.

The method shown in FIG. 8 can be particularly advantageous in waste collection scenarios where multiple bins or service points may be located near each other, such as curbside residential streets, apartment complexes, commercial facilities, or industrial sites. The combination of PSV factors, identifier recognition, and wireless detection allows the system to differentiate among adjacent micro-locations, confirm service completion, and generate reliable data for historical mapping, optimization of collection routes, and performance analysis.

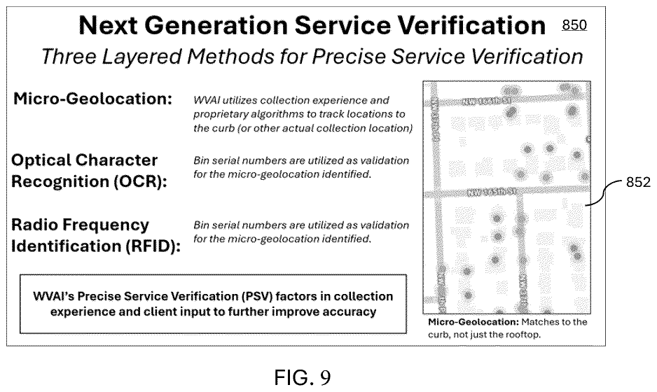

FIG. 9 illustrates a diagram outlining features of micro-geolocation verification 850 in the context of a collection scenario, in accordance with another embodiment. It should be appreciated that although the particular scenario depicted in FIG. 9 relates to waste collection, such as the collection of residential waste bins, curbside garbage cans, industrial containers, or similar objects, numerous alternative use cases can be implemented in accordance with other embodiments. For example, the techniques illustrated can be applied to package delivery, recycling collection, sample retrieval, utility inspection, or other service activities requiring precise location verification.

The scenario shown in FIG. 9 involves the use of an artificial intelligence (AI) application referred to as “Wastevision AI” or WVAI, which can leverage historical collection experience, sensor data, and proprietary algorithms to track the precise micro-geolocation of objects at the curb or other actual collection locations. In embodiments, WVAI may incorporate multiple PSV factors, including collection experience, environmental or sensor data, and client input, to enhance the accuracy and reliability of micro-geolocation determination.

Identifier recognition techniques, such as optical character recognition (OCR), barcode decoding, QR code decoding, symbol recognition, or other identifier detection processes as discussed previously, may be utilized to identify unique identifiers on objects, such as bin serial numbers. The recognition of such identifiers can serve as validation for the micro-geolocation determined by WVAI. In addition, wireless identification elements, including radio frequency identification (RFID) tags, near-field communication (NFC) devices, Bluetooth beacons, wireless transponders, or other wireless signaling devices, may be associated with the objects to provide an additional layer of verification. The combination of identifier recognition and wireless detection enables the system to confirm that a service event occurs at the correct physical location with high confidence.

FIG. 9 illustrates a three-layered approach to precise service verification. The first layer includes dynamic determination of the micro-geolocation using PSV factors and AI-based analysis. The second layer involves verification using identifier recognition, including OCR or other visual or electronic techniques. The third layer includes confirmation through detection of a wireless identification element associated with the object. Together, these layers provide a robust framework for verifying that service events, such as collection or delivery, occur at the intended micro-geolocation rather than simply at a general location such as the center of a property or rooftop of a building.

A map graphic 852 shown in FIG. 9 depicts an example micro-geolocation scenario in which WVAI identifies precise matches to the curb or designated collection location for each object, rather than only to approximate property coordinates. The map may visually illustrate the object locations, verified identifiers, wireless detection coverage, and service completion records, providing a comprehensive view of micro-geolocation verification in the context of a collection operation.

In additional embodiments, the layered micro-geolocation verification framework illustrated in FIG. 9 can be applied to multi-tenant properties, shared delivery zones, or other complex service environments. For example, in a multi-unit residential building, a delivery or collection service may need to verify the micro-geolocation of individual units, common areas, or specific drop-off points for each tenant. WVAI can utilize PSV factors, sensor data, client input, and historical service records to dynamically determine the correct micro-geolocation for each service event within the property. Identifier recognition operations, such as reading serial numbers on containers, access points, or equipment, and wireless identification elements, including RFID tags, NFC devices, or Bluetooth beacons, can be associated with individual units or designated service zones. This ensures that the micro-geolocation verification accurately distinguishes between tenants and service-eligible areas.

In such complex scenarios, WVAI may integrate multiple data sources, including visual imagery, sensor measurements, and geofencing information, to confirm the exact location of service events. Captured images, timestamps, and generated verification records can be linked to specific tenants, collection points, or delivery zones, providing a comprehensive audit trail for accountability, reporting, and billing purposes. By combining AI-driven analysis with identifier recognition and wireless detection in a three-layered approach, method 200 can ensure precise verification of service events at the intended micro-geolocation, even in environments where multiple objects, service zones, or tenants are present within a shared property footprint.

This layered approach allows the embodiments to adapt to diverse operational contexts, such as package deliveries in apartment complexes, selective waste or recycling collection, maintenance and inspection of meters or utility access points, and other service activities where precise micro-geolocation verification is critical for accuracy, compliance, and service validation.

In another embodiment, overflow from a waste container can be automatically identified, classified, and recorded as part of a waste collection service. In this embodiment, a trigger mechanism detects or infers that a waste collection service is occurring with respect to a particular waste container. The trigger mechanism may include, for example, an RFID device that detects proximity of a service vehicle or lifting arm, a distance sensor or tilt sensor that identifies container movement consistent with servicing, or an artificial intelligence (AI) model trained to visually recognize a container involved in a collection activity. Upon activation of the trigger mechanism, the system initiates the capture of one or more images or video frames of the waste container during the service event.

The captured imagery can be processed by one or more AI models configured to determine whether the waste container is in an overflow condition. The AI model may evaluate visual characteristics such as material protruding above the rim of the container, displacement of the container lid, visibility of excess contents, or other image-based indicators. In some implementations, the AI model is further configured to classify the overflow condition according to varying levels of severity, including marginal, moderate, or egregious overflow states. Classification of overflow severity may allow a service provider, municipality, or regulatory entity to tailor subsequent responses, improve reporting accuracy, or support enforcement and educational programs.

In certain embodiments, the system additionally generates a timestamp and geolocation associated with the captured imagery, enabling precise contextualization of the overflow event. The system may also associate the overflow incident with a generator of the waste container using geolocation metadata, optical character recognition (OCR) applied to identifying markings or serial numbers on the container, and/or RFID data obtained during the collection service. This combination of image analysis, location intelligence, and container identification provides a verifiable record that links the detected overflow condition to a specific generator and service event.

A corresponding system embodiment may include one or more sensors, image-capture devices, and trigger components mounted to or communicatively coupled with a waste collection vehicle or other service platform. The system may further include an onboard edge device configured to receive trigger signals, control the capture of video or imagery, and perform preliminary or full AI-based overflow detection. In some implementations, the edge device communicates with a cloud-based analytics platform for additional processing, archival storage, alert generation, or integration into customer-facing reporting systems. The system may also incorporate a communication interface for transmitting overflow determinations, severity classifications, timestamps, and generator information to backend management systems or third-party applications.

These embodiments allow overflow conditions to be detected automatically, consistently, and without requiring manual driver input, thereby increasing operational efficiency and accuracy in documenting non-compliant or overloaded containers. The resulting data can support a wide range of downstream functions, including route optimization, customer education, fine assessment, service verification, or compliance auditing. Combined with other sensing and verification capabilities disclosed herein, the overflow-detection embodiments provide a robust and scalable framework for enhancing the quality and accountability of waste collection services.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for identifying materials in a waste stream, comprising:
receiving a request from a requester to assess waste within or obtained from a waste container;
acquiring media data from at least one sensor positioned to capture data indicative of the waste during handling, transport, or processing of the waste; and
processing the media data to identify individual materials represented therein, generating a data file containing results of the processing, and transmitting a response to the requester that initiated the request, the response including the data file and information identifying the materials.

2. The method of claim 1 wherein the response includes the data file and the information identifying the materials found together with at least one of: an identification of the waste container, a location associated with the waste container, or a generator of the waste materials contained therein.

3. The method of claim 1, wherein the media data comprises still images, video, or combinations thereof acquired from at least one camera.

4. The method of claim 1, wherein the processing is performed by an artificial intelligence (AI) system configured to analyze the media data to determine classes of materials contained in the waste.

5. The method of claim 1, wherein the processing of the media data is performed via a cloud-based system configured to automatically analyze the media data to reduce or remove human interpretation or error, thereby improving accuracy, reducing costs, and streamlining the process of identifying materials in the waste stream.

6. The method of claim 1, wherein the processing includes identifying the materials within the waste and generating an indication or report that enables the requester to take an action in accordance with applicable laws or ordinances.

7. The method of claim 6, wherein the action comprises at least one of: issuing a warning, providing educational information, assessing a fine, or suspending waste collection service for the identified generator.

8. The method of claim 1, further comprising performing preliminary processing of the media data on an onboard edge device mounted to a waste collection vehicle.

9. A method for identifying materials in a waste stream, comprising:
receiving a request from a requester to assess waste within or obtained from a waste container;
acquiring media data from at least one sensor positioned to capture data indicative of the waste during handling, transport, or processing of the waste; and
processing the media data to identify individual materials represented therein, generating a data file containing results of the processing, and transmitting a response to the requester that initiated the request, the response including the data file and information identifying the materials found together with at least one of: an identification of the waste container, a location associated with the waste container, or a generator of the waste materials contained therein.

10. The method of claim 9, wherein the at least one sensor comprises at least one of: a camera, an image sensor, a depth sensor, a thermal sensor, a LiDAR sensor, or a multispectral sensor.

11. The method of claim 9, wherein the media data comprises still images, video, or combinations thereof acquired from the at least one sensor.

12. The method of claim 9, further comprising performing preliminary processing of the media data on an onboard edge device operatively coupled to the at least one sensor.

13. The method of claim 12, wherein the preliminary processing includes executing processing logic configured to analyze the media data prior to transmission to a remote processing platform.

14. A system for identifying materials in a waste stream, comprising:
an onboard edge device mounted to a waste collection vehicle;
at least one sensor operatively coupled to the onboard edge device and positioned to capture media data indicative of waste during handling, transport, or processing of the waste; and
a processing component implemented by the onboard edge device and configured to process the media data to identify individual materials represented therein and to generate a data file containing results of the processing.

15. The system of claim 14, wherein the at least one sensor comprises at least one of: a camera, an image sensor, a depth sensor, a thermal sensor, a LiDAR sensor, or a multispectral sensor.

16. The system of claim 14, wherein acquiring the media data comprises acquiring still images or video streams from the at least one sensor positioned in association with at least one of: a waste container or a waste collection vehicle so as to capture multiple perspectives of the waste during handling, transport, or processing.

17. The system of claim 14, further comprising performing preliminary processing of the media data on the onboard edge device mounted to the waste collection vehicle, the preliminary processing includes determining whether evidence of contamination is present.

18. The system of claim 14, wherein processing the media data includes employing image recognition to identify an identifier associated with the waste container.

19. The system of claim 18, wherein the transmitted response further includes a container identification derived from the image recognition of the identifier.

20. The system of claim 14, wherein a micro-geolocation of a waste collection event is verified by:
dynamically determining a micro-geolocation associated with the waste collection event based on precise service verification (PSV) factors including at least one of: service experience data and client input;
verifying the micro-geolocation by performing an identifier recognition operation on an identifier located on a waste container within a vicinity of the micro-geolocation; and
confirming the micro-geolocation based on detection of a wireless identification element associated with at least one of: the waste container or the waste collection event.

21. A method for detecting overflow of a waste container, comprising:
receiving, from a trigger mechanism, a notification indicating that a waste collection service is being performed with respect to a waste container;
capturing, in response to the notification, at least one video or at least one image of the waste container during the waste collection service; and
analyzing the at least one video or the at least one image using an artificial intelligence (AI) model to determine whether the waste container is in an overflow condition.

22. The method of claim 21, further comprising:
classifying a severity level of the overflow condition, wherein the severity level ranges from marginal to egregious or a similar severity scale, based on output from the AI model.

23. The method of claim 21, wherein the trigger mechanism comprises at least one of:
an RFID device;
a distance sensor;
a tilt sensor; and
an AI-based detector configured to recognize the waste container.

24. The method of claim 21, further comprising:
generating, in association with the at least one video or the at least one image, a timestamp and a geolocation; and
associating the detected overflow condition with a generator of the waste container using at least one of: the geolocation, optical character recognition applied to identifying information in the captured video or image, and data obtained from RFID.
